(19) United States
(12) Patent Application Publication
(10) Pub. No.: US 2012/0011590 A1
(43) Pub. Date: Jan. 12, 2012

(54) SYSTEMS, METHODS AND DEVICES FOR PROVIDING SITUATIONAL AWARENESS, MITIGATION, RISK ANALYSIS OF ASSETS, APPLICATIONS AND INFRASTRUCTURE IN THE INTERNET AND CLOUD

(76) Inventor: John Joseph Donovan, Hamilton, MA (US)

(21) Appl. No.: 12/834,378

(22) Filed: Jul. 12, 2010

(51) Int. Cl. G06F 11/00

(52) U.S. Cl. 726/25

(57) ABSTRACT

The present invention determines a situational awareness for alerting, mitigating error, distortion or failures, and managing the Internet (or equally component intranets), connected networks and cloud infrastructure. Specifically, this invention focuses on determining who originates messages, from what system, and the path taken, thereby analyzing the reputation of all the nodes and links through which data passes.

It can provide a mechanism determine the ongoing veracity of the “purported” device, and maintain a reputation database of devices, data, applications and networks for analysis of how the Internet is being used or potentially subverted—effectively creating a score indicating component and total system integrity. It can calculate a correlation of risk analysis of all adjacent data describing the universe of the Internet. This invention will be particularly useful for helping detect and mitigate compromises to data, networks, systems and other assets within the Internet and Cloud.

### FIELD OF THE INVENTION

The present invention is generally related to the security, performance, reputation, and integrity of the internet and the cloud. More specifically, this invention relates to a system, method, and apparatus for detecting compromise of DNS servers, IP devices, paths, email, real-time and historical information all of which make-up the internet portion of cloud hosting. The present invention may be used to fight vulnerabilities of data, applications, devices, and other assets in the cloud and the internet.

### BACKGROUND OF THE INVENTION

The evolution of deploying applications, servers, and assets has gone from a mainframe environment to a client/server environment to an internet environment and now to the cloud. This has been driven by the economics of a return-on-investment that has been gained by sharing applications, infrastructure and internet. And the gradual shift of what were strategic applications such as sales force automation to being a commodity. These commodity applications are necessary but do not need to be proprietary.

IT professionals and business personnel have elected to use the cloud to host their applications and access them through the internet. For example, salesforce.com may be hosted on a cloud offered by Amazon. Quickbooks.com can be accessed in a cloud environment as opposed to multiple, redundant and/or expensive data centers.

This cloud market is estimated at $50B and growing at 20% annually. However, this eclectic set of technologies comprised in the cloud and internet access has led to massive vulnerabilities in management and security.

For example known vulnerabilities have been reported in the literature:

Locking Down the Cloud: Why DNS Security Must Be Improved (InformationWeek, Sep. 27, 2008)

http://www.informationweek.com/news/internet/security/showArticle.jhtml?articleID=210603893

For example:

Cyber attacks knock out Georgia's Internet presence (Computerworld, Aug. 11, 2008)

http://www.computerworld.com/action/article.do?command=viewArticleBasic&articleId=9112201

The reputation database embodiment of this invention will address this type of vulnerability.

For example:

Corrupted DNS Resolution Paths: The Rise of a Malicious Resolution Authority (College of Computing, Georgia Institute of Technology; College of Engineering, Georgia Institute of Technology)

The correlation embodiment of this invention will address this type of vulnerability.

http://www.darkreading.com/security/app-security/showArticle.jhtml?articleID=208803842

http://www.citi.umich.edu/u/provos/papers/ndss08_dns.pdf

The DNS database within the internet is a rising attack vector. A perpetrator can change a corporations customer's DNS resolver settings very easily and the results can be devastating for both the customer and the online resource they are accessing. Most importantly, all communication, email and web, can be redirected to malicious sources.

Drive-by alterations of DNS data host files is a looming threat. The Google/GA Tech study points to the growing threat associated with individual computers being directed to use rogue DNS services instead of those natural DNS servers provided by their network. This of course is different from traditional DNS attacks, such as poisoning, because the individual user's computer is targeted, instead of servers. . . . “since (these attacks) involve only the victim and a complicit remote server, the attack is difficult to witness outside of the local network.”

For example:

Vast Spy System Loots Computers in 103 Countries (New York Times, Mar. 29, 2009)

http://www.nytimes.com/2009/03/29/technology/29spy.html?_r=1&scp=1&sq=Vast%20Spy%20System%20Loots%20Computers%20in%20103%20Countries&st=cse

Computer based software (malware) clandestinely steals unknowing users data, “ . . . infiltrating at least 1,295 computers in 103 countries, including many belonging to embassies, foreign ministries and other government offices.” “The spy operation is still going strong and continues to invade and monitor more than a dozen new computers a week.” “The malware is remarkable both for its sweep—in computer jargon, it has not been merely “phishing” for random consumers' information, but “whaling” for particular important targets”

It can, for example, turn on the camera and audio-recording functions of an infected computer, enabling monitors to see and hear what goes on in a room. The investigators say they do not know if this facet has been employed.” “What Chinese spooks did in 2008, Russian crooks will do in 2010 and even low-budget criminals from less developed countries will follow in due course,” the Cambridge researchers, Shishir Nagaraja and Ross Anderson, wrote in their report, “The Snooping Dragon: Social Malware Surveillance of the Tibetan Movement.”

The IP validation embodiment of this invention specifically addresses this vulnerability.

For example:

“A high-tech tip, an old-school stakeout in Craigslist attacks” The Boston Globe, Apr. 23, 2009.

http://www.boston.com/news/local/massachusetts/articles/2009/04/23/a_high_tech_tip_an_old_school_stakeout/

“A computer identification code known as an IP address was the first clue to draw police to the luxury towers in Quincy, where Markoff lived in a $1,400-a-month one-bedroom apartment.” This invention would go much further using not only the IP address, but also the entire environment including network paths, log files, location information, telephone records to not only identify the computer involved but the user, location, access history, other sites visited/targets and correspondence as well.

The Who Sent embodiment of this invention will specifically address this vulnerability.

### BRIEF SUMMARY OF THE INVENTION

One embodiment of the present invention is a method for giving situational awareness and alerting on the following conditions:
1. Who sent—determining who messages really came from, the path taken, the reputation of all the servers through which they passed and in depth analysis of the content structure, including links in the messages themselves.
2. IP Device Authentication—provide a mechanism and judgment to determine the ongoing veracity of the “purported” device with such parameters as unique device ID, history of access, paths taken and other environmental data
3. Reputation Database—the internet is a collection of devices, data, applications, users and networks. We present here a mechanism for observing in real time, and putting those observations into a database for contextual evaluation and analysis of how the internet is being used or potentially subverted—real time evaluation of DNS database changes, server logs, device logs and path resolution.
4. Risk Analysis—A correlation of risk analysis of all adjacent data describing the universe of the internet. Observability is on all data acquired. In real world constructs we are hampered by the amount of work necessary to collect (observe) data—the networked infrastructure implicitly produces that data and hence mechanisms and methods for risk analysis are presented here leading to a dashboard for all assets of the cloud.

### BRIEF DESCRIPTION OF THE DRAWINGS

FIG. 1 illustrates a systems architecture for situational awareness of assets in the cloud, including the data center (traditional storage devices, processes, email devices), traditional network management capabilities (security, performance, monitoring; e.g. Tivoli), users accessing their services in the cloud via the internet. The lower part of FIG. 1 depicts the focus of this patent. Network access points, network paths, connected devices, gateways, DNS data, log files, load analysis produces a natural, discernible, mathematical model of the Internet. Based on this model, events and contexts may be predictable as aberrations occur. This model will make these aberrations and their effects transparent.

FIG. 1 also depicts the log files for routers, databases for DNS servers, the reputational database, analytics for analyzing the reputational engine, etc. Includes system (alert engine, Who Sent, IP authentication, reputation database, and analysis/correlation) and software assets to make it possible to monitor in the cloud and internet.

FIG. 2—illustrates the IP device parameters that may be used to authenticate a device.

FIG. 3—depicting example data populating the reputation database.

FIG. 4—depicts an example alert notification of a compromise that has occurred with an accounting application and the automatic actions taken.

FIG. 5—depicts an example of the relationship between the applications and observed risks, the larger the circle the higher the risk.

FIG. 6—depicts an example of mitigation and reports sent compromise in an accounting application.

FIG. 7—depicts an example of threshold risk analysis of an intrusion.

FIG. 8—depicts an example dashboard for contextualized situational awareness.

FIG. 9—depicts a risk analysis of compounded event such as change in reputation data involving email blacklisting and paths.

FIG. 10—depicts an example risk analysis of data center breach correlating physical intrusion detection, log file changes, DNS changes, etc.

FIG. 11—example of mitigation alerting to a security breach and physical configuration of a facility.

FIG. 12—example of an escalation of alert for a security breach whereby if no response to mitigation takes place an orderly notification of other possible mitigation mechanisms takes place.

FIG. 13—example of a presentation layer on an Apple iPhone device.

FIG. 14—example of an automatic, customizable, forensic analysis of alerted situation.

FIG. 15—example of existing data detailing internet view of domain and internet accessible assets.

FIG. 16—example of three-tier implementation architecture for analysis/correlation, Who Sent, alert engine, IP authentication and reputation database components.

FIG. 17—example of set theoretical view of the forensic analysis.

### DETAILED DESCRIPTION OF THE INVENTION

The present invention provides a system, a method, and an apparatus for situational awareness of many aspects of the internet, networks and cloud infrastructure.

### Definitions

“Food Chain” associated with the Cloud:

User (e.g. Chief Financial Officer)

Applications provider (e.g. Salesforce.com, QuickBooks)

Cloud Hosting (e.g. Amazon)

Supporting Software (e.g. DNSstuff, IBM Tivoli, HP Openview)

Hardware Vendors (e.g. HP, IBM, EMC, etc.)

Chips (e.g. Intel, Qualcomm, AMD)

“Cloud”—from the viewpoint of the user it is a general utility that handles all his/her applications, software and hardware needs. He/She may be charged by the transaction.

“Applications Providers”—from the viewpoint of the application provider the cloud is a deployment utility for efficiently providing their application to a large number of users.

“Hosting” from the viewpoint of the hosting provider is a collection of servers, mainframes, storage units, the internet, all of the hardware and software to host multiple applications

“Hardware/Software vendors” form the point of view the cloud is a new and changing market for hardware, software and consulting services, as cloud adoption grows need for self-fielded equipment will decline and need for hardware for the cloud service providers will increase.

“DNS (Domain Name System)” is one of the largest databases in the world consisting of all the pathways to devices and assets in the internet.

As used herein, the term “meta-data” shall designate data about data. Examples of meta-data include primitive events, (including changes in DNS, network paths, IP device identification), compound events, meta-data extracted from independent tips, network events, device information, and external information provided by government and law enforcement and other consortium. Meta-data also includes compound events and correlated events, defined below. Meta-data also includes information added manually by a human reviewer, such as a person who reviews tips and reports.

“BGP (Border Gateway Protocol)” is one expression of the current optimal routes on the internet.

“Primitive events” may be generated automatically by various devices, or may be generated in software based on data from various databases.

In one embodiment, a human operator adds meta-data and thereby generates primitive events. For example, a human operator may add meta-data indicating, “suspicious activity was observed at this location which houses servers.”

As used herein, “correlated events” shall include primitive and/or compound events that have been correlated across either data servers, space or time. An example of a correlated event is a change to DNS email settings correlated to a change in listing on blacklists and a change in network paths.

As used herein, the term “attribute data shall designate data about IP devices or sources (such as DNS data), such as the quality of the data produced by the IP devices, the age of the IP devices or data, time since the IP devices or data were last maintained, integrity of the IP devices or data, reliability of the IP devices or data, and so on. Attribute data has associated weights.

In the case of tips, attribute data refers to data about the source of the tips. For example, a tip from an anonymous submitter will have different weights corresponding to the attribute data than a tip submitted by a law enforcement officer.

Contextual attribute data is stored with the reputation data, and corresponds to the attribute data of the device that captured the data. For example, the meta-data is stored with access to the same context of the data.

“Meta-data” (primitive events, compound events, correlated events, etc.) and attribute data are used throughout the present invention. Meta-data in the form of primitive events is used to detect compound events of higher value. Primitive and compound events are correlated across space and time to generate additional meta-data of even higher value. The events are weighted according to the attribute data corresponding to the devices that generated the events. Primitive, compound, and correlated events may trigger one or more intelligent alerts to one or more destinations. The meta-data is also used for forensic analysis to search and retrieve data by event.

Meta-data and attribute data are both used for event correlation, for network management, and detection of vulnerabilities.

Finally, the analysis of a set of correlated events may lead to “resetting” (flip flop) of the entire decision tree that led to the alert.

### Systems Architecture

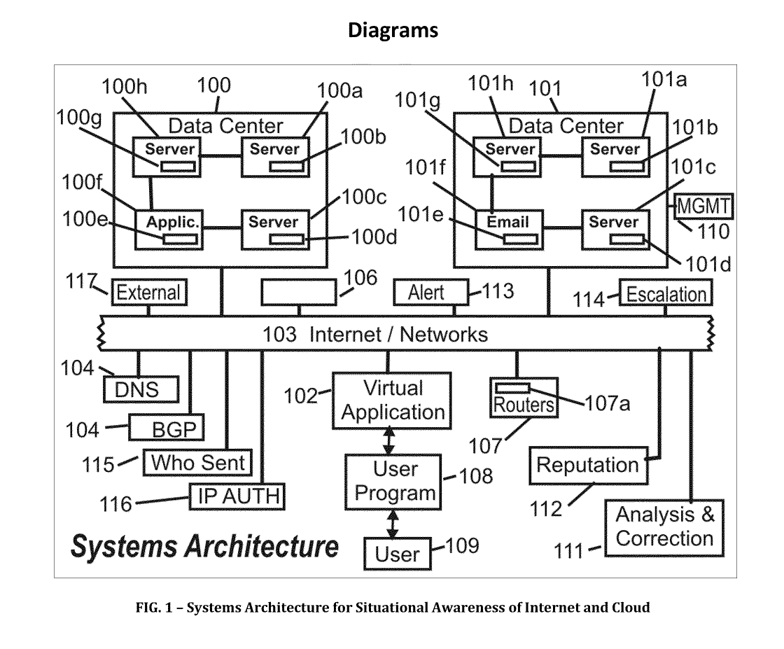

One embodiment of the present invention is a system, a method, and an apparatus for data surveillance, vulnerabilities detection and alerting in a cloud environment. FIG. 1 shows an example of a system architecture of one embodiment of the present invention related to a cloud and internet. Data centers 100 and 101 house collections of computers (100a, 100c, 100h, 101a, 101c and 101h) and other resources (100f and 101f) they are managed by traditional network management software (110) (e.g. HP Openview). These data centers are accessible via the network (103), internet (103) and the required infrastructure (100f and 101f) to support the activity of the virtual applications (102) (e.g. SalesForce.com) provided by such equipment. Additionally the health, status, and network (103) connectivity of all components and subsystems/infrastructure (104, 105, 106 and 107) of the connected systems are stored in logs (100b, 100d, 100g, 101b, 101d, 101g and 107a). Systems are hosted including virtual applications (102), user programs (108) and users (109). For example, a user opens a web browser and accesses an application running in virtual datacenters. Data traverses systems and paths and this activity can be observed and memorialized for normalization and comparison and action (111, 112, 113, 114, 115 and 116).

One embodiment of the invention, Who Sent (115), reputation (112), analysis (111) captures its data and information from all sources of FIG. 1 including external (117) and components 100-109.

The alert engine (113) is triggered by the analysis (111) engine. The escalation engine (114) has dynamic and customizable rules activated by all data sources. The management tools (110) are traditional tools that produce independent reports on performance, etc and provide data to the analytics engine (111) for situational awareness.

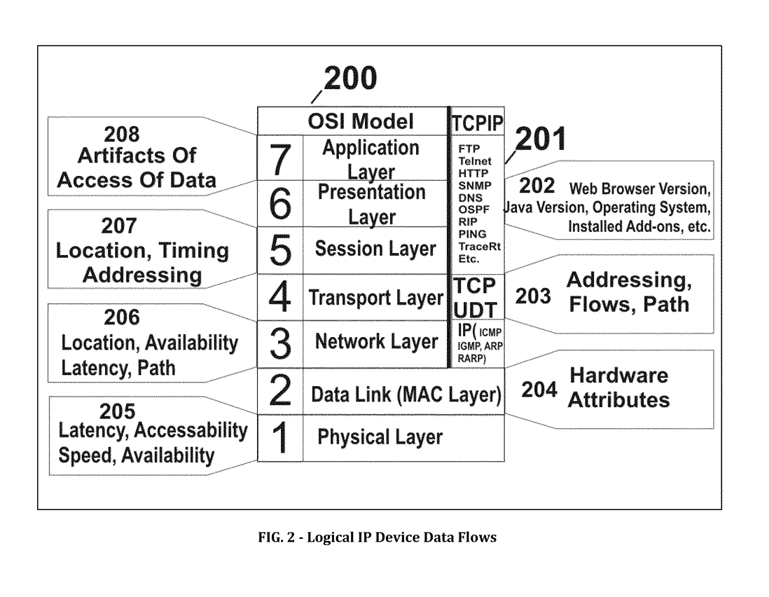

FIG. 2 depicts the architecture (200) for data sources for IP device data sources for use in authentication (FIG. 1, 116) by the correlation process (111). Primitive events, context and data are expressed (202, 203, 204, 205, 206, 207 and 208). The OSI model (201) is representative of the multiple interfaces for data gathering.

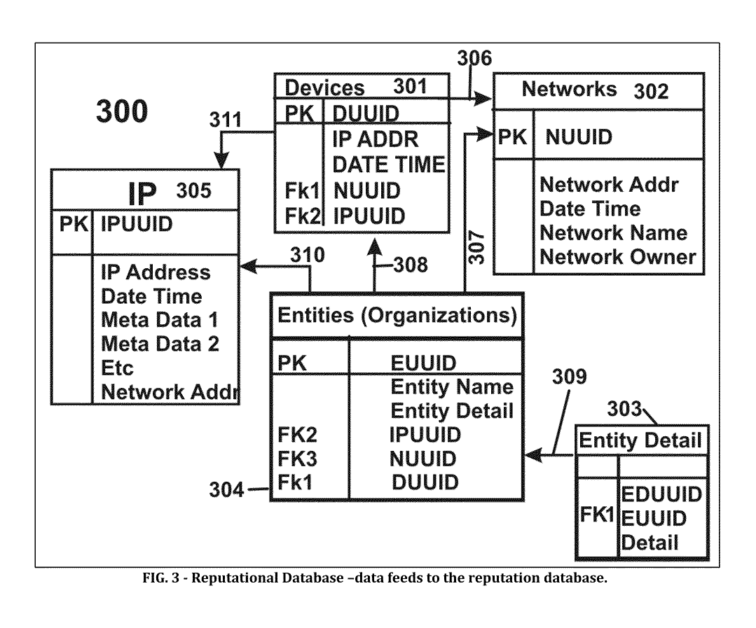

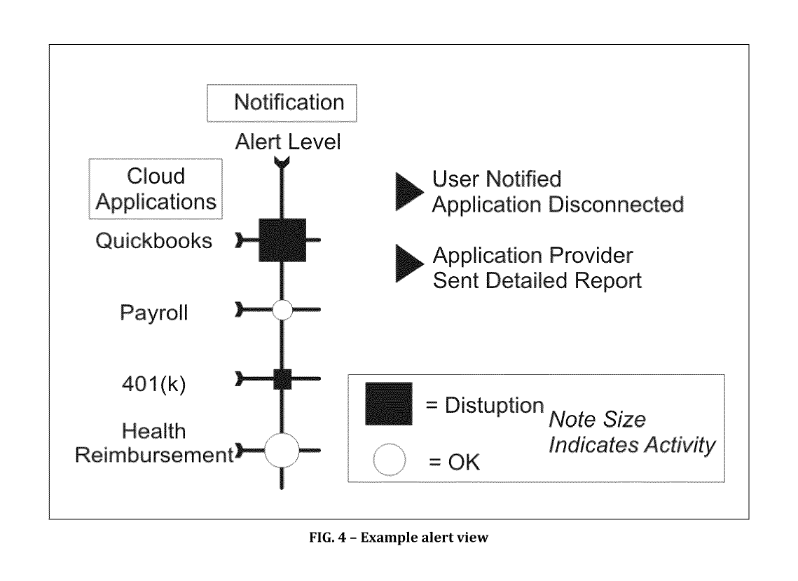

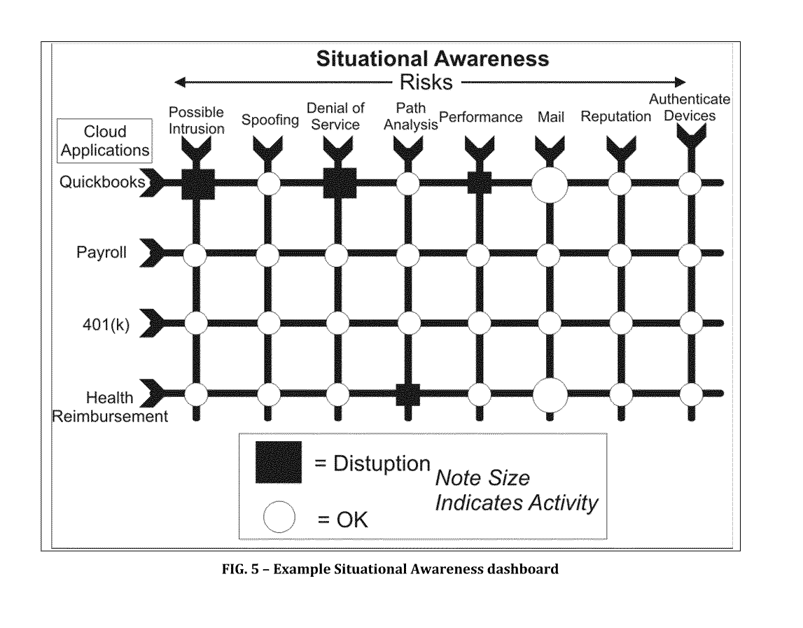

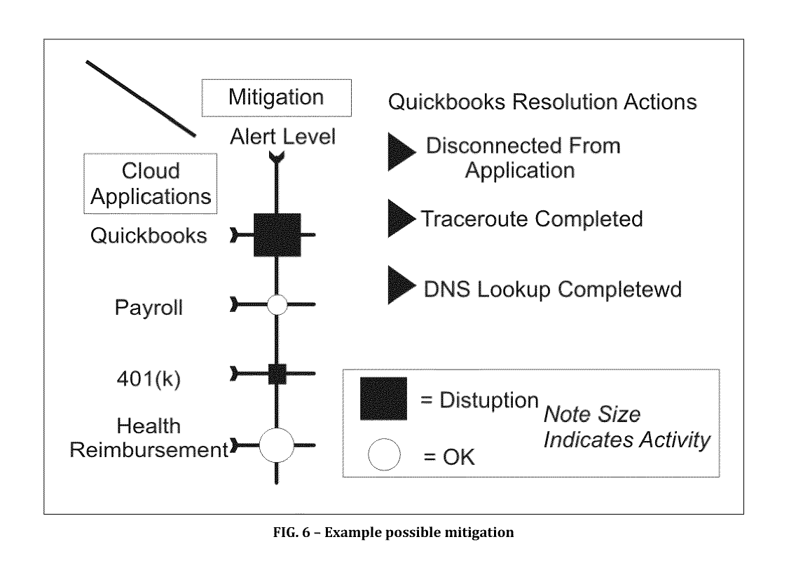

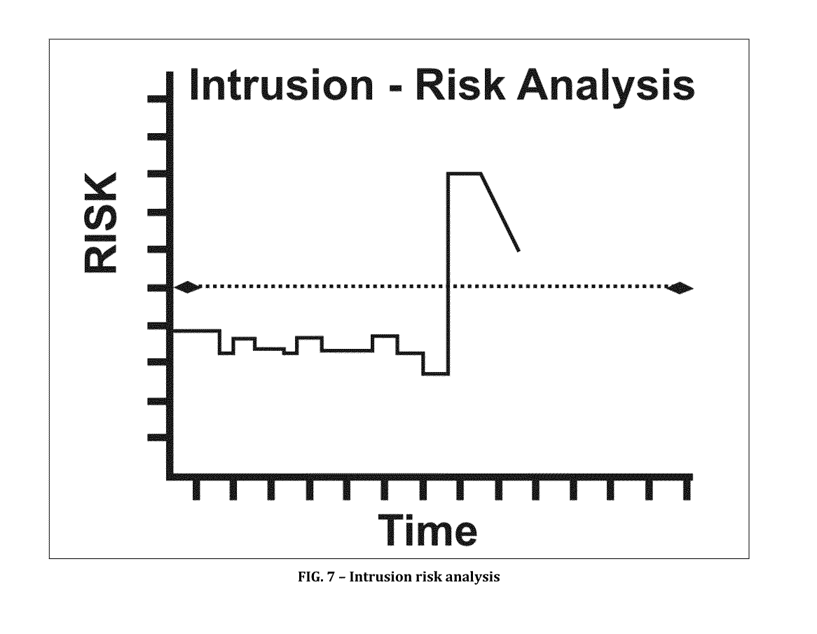

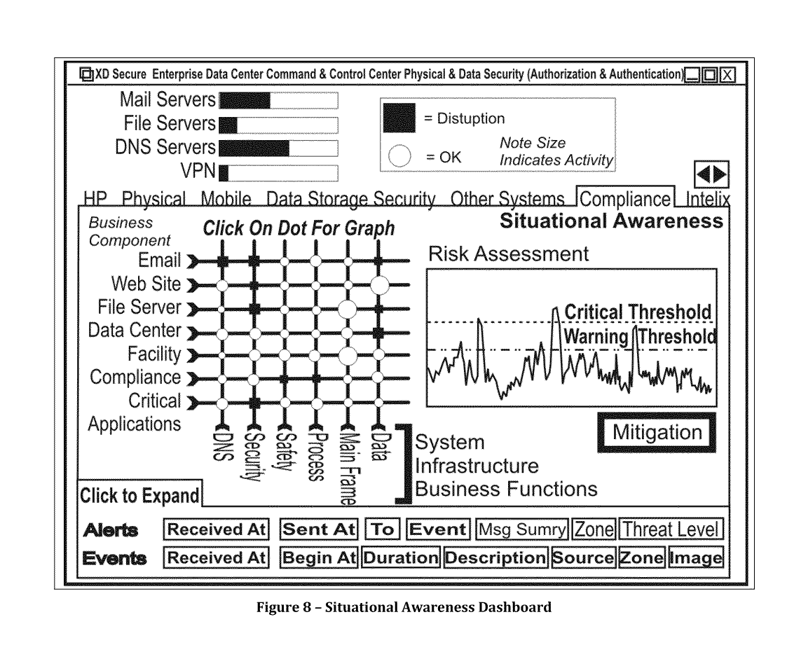

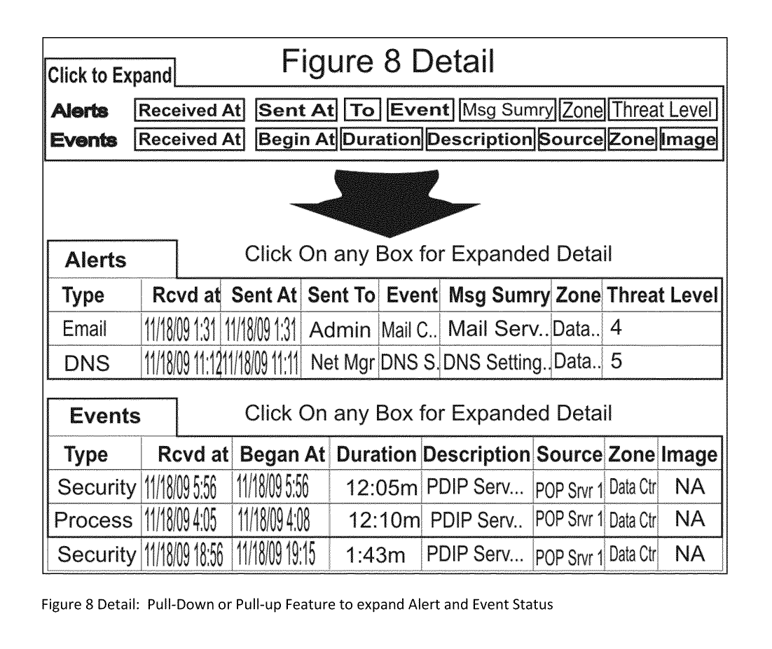

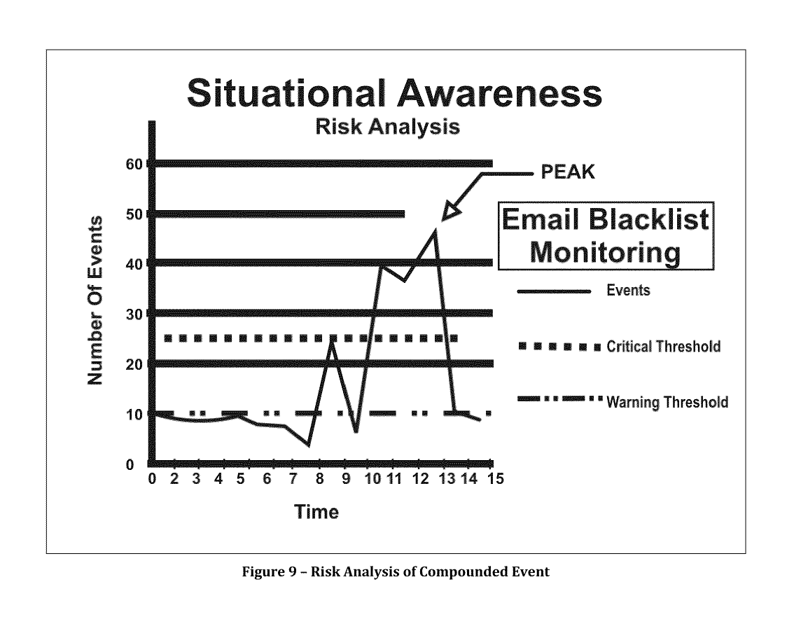

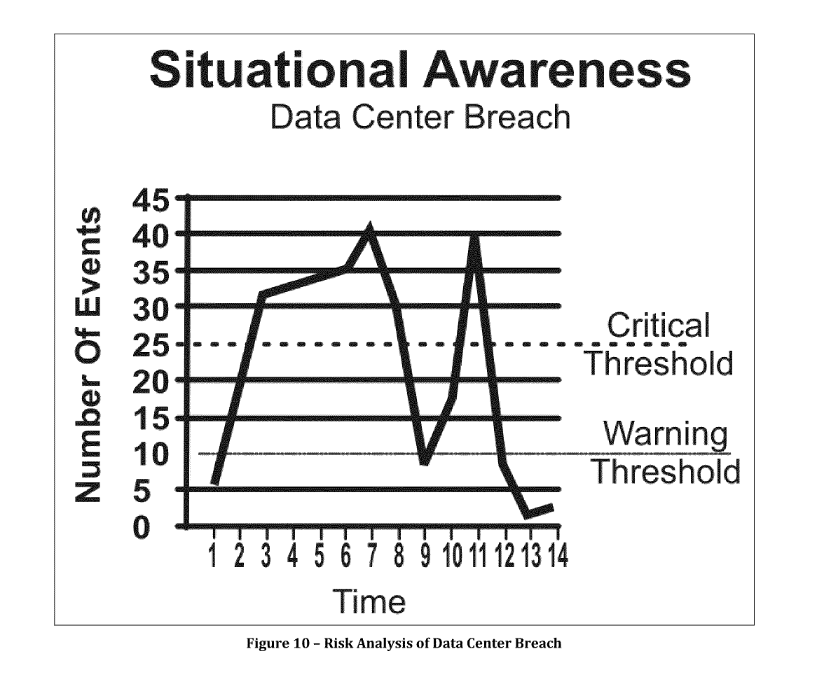

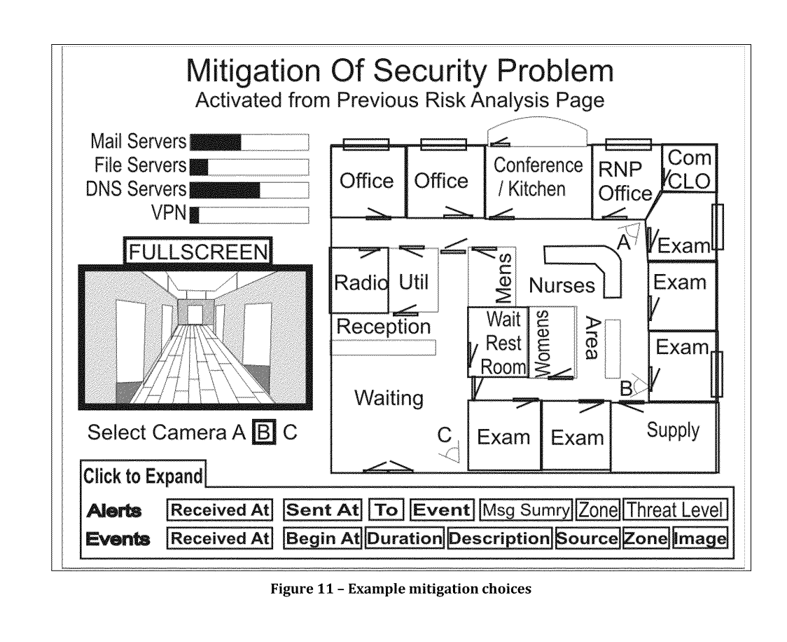

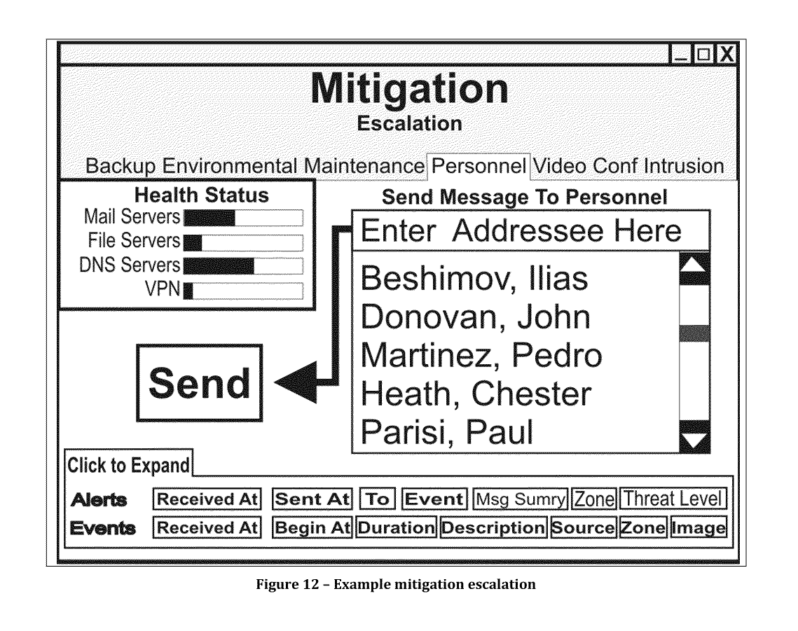

FIG. 3 depicts the common data storage model (300) for the correlation of data available in FIG. 1 (112) and FIG. 2. Tables (301, 302, 303, 304 and 305) and their relationships (306, 307, 308, 309, 310 and 311) are used to retain the data's context as it was discovered in the entire environment (FIG. 1, 112). This data is fed into the correlation process (FIG. 1, 111), discrepancies are noted, weighted, displayed (examples FIGS. 5 and 6) and appropriate alerts determined by the alert engine (FIG. 1, 113). Examples displayed in FIGS. 4 and 11 are generated along with possible mitigation actions (example FIGS. 6 and 11). Analysis's are then performed by the risk analysis engine (FIG. 1, 111) and displayed in examples FIGS. 7, 9 and 10. Further, escalation possibilities are shown in FIG. 12 as determined by the escalation engine (FIG. 1, 114).

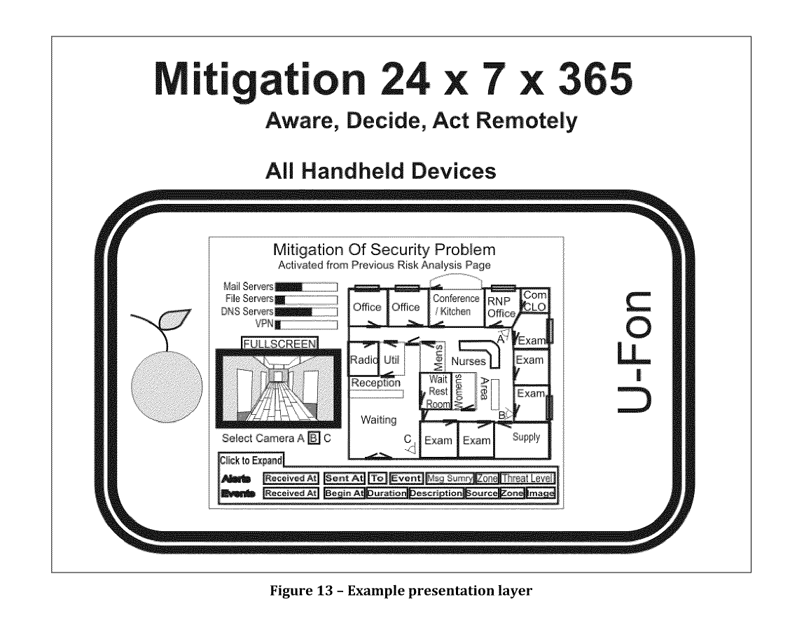

FIG. 13 depicts a sample graphical user interface to allow authorized personnel to interact with the system and the alerts, mitigation steps and data produced by it.

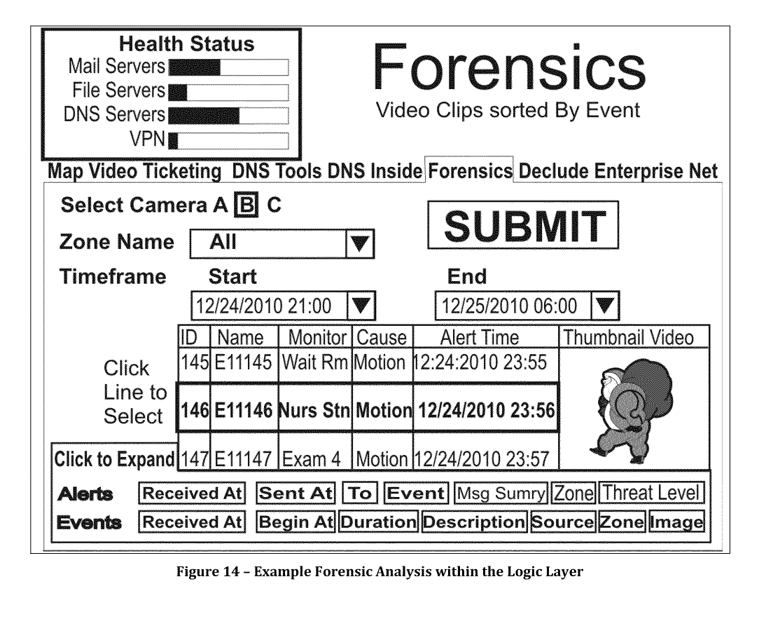

FIG. 14 depicts a sample forensic analysis generated by the analysis/correlation engine (FIG. 1, 111).

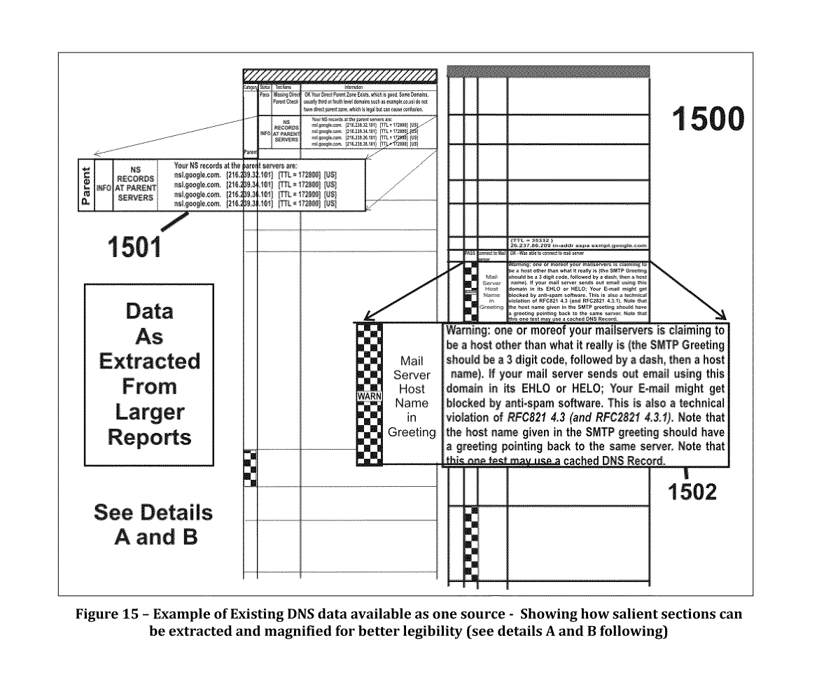

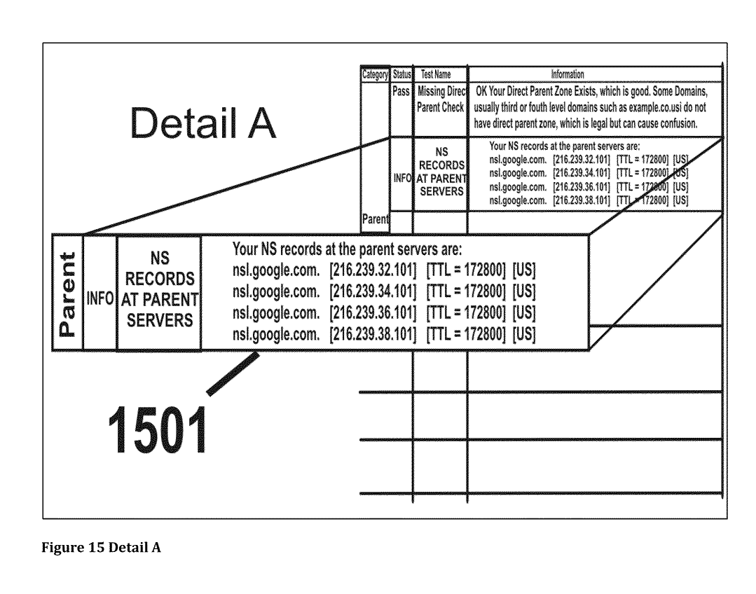

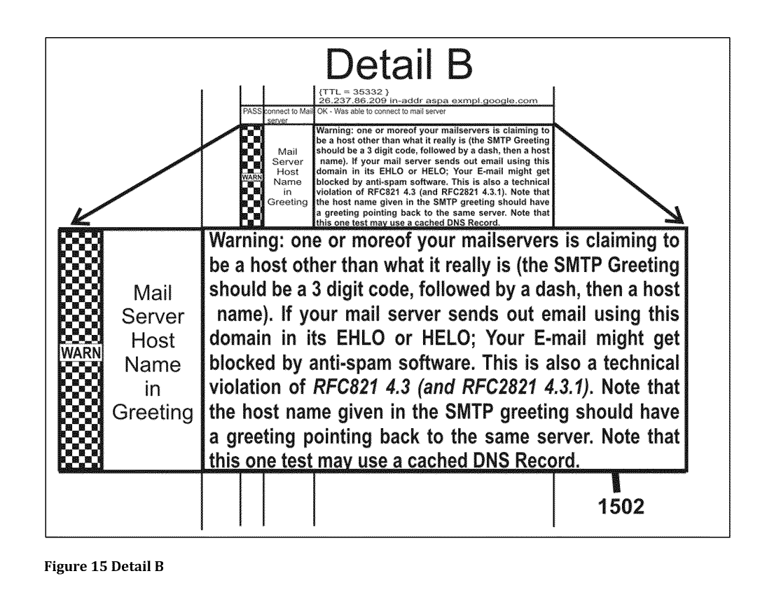

FIG. 15 depicts example existing data (1500) accessed by the analytics engine (FIG. 1, 111) and use such data as identification (1501) and presents a report displaying the conflict of email server names (1502).

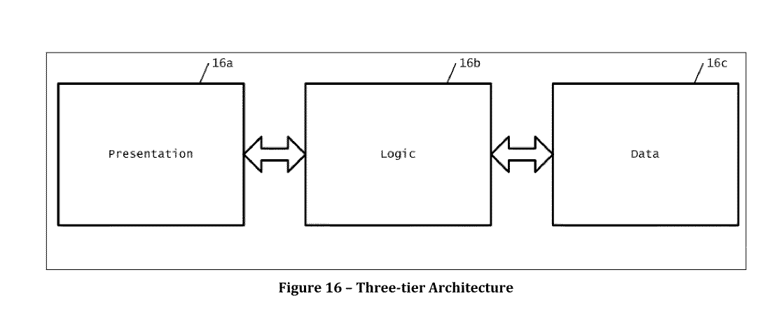

FIG. 16 demonstrates the context for each of three tiers used to deliver the required functionality. 16a shows the area responsible for the presentation, 16b illustrates the logic area and 16c is the area in which data is stored.

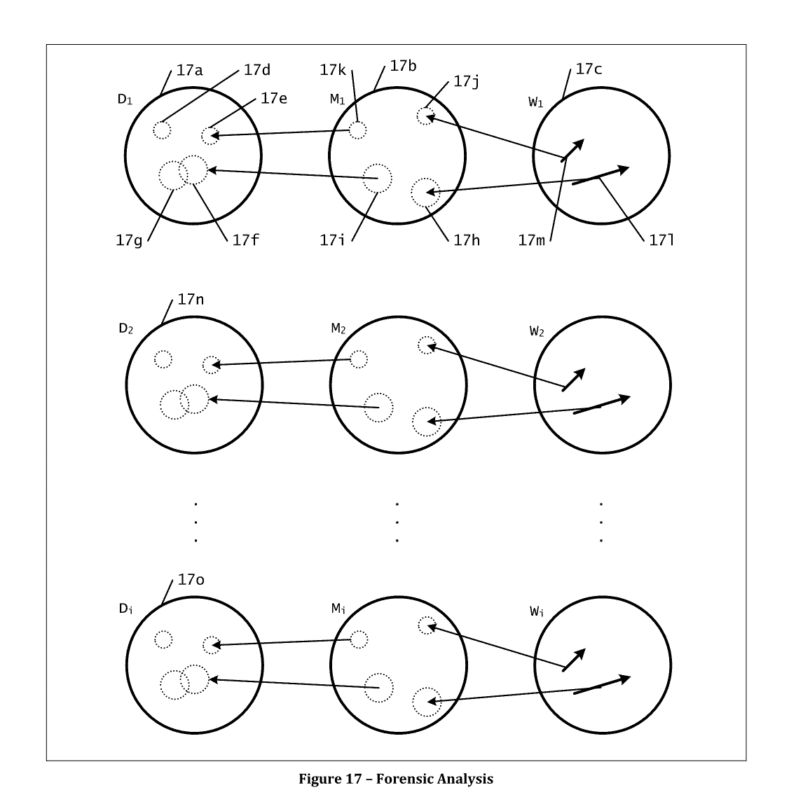

FIG. 17 depicts a set theoretical model for forensics which will be explained in the forensics section of this document.

### Detection of Improper “Whosent”

Determine who messages really came from, the path taken, the reputation of all the servers through which it passed and in depth analysis of the content, including links, in the message itself (FIG. 1, 115). Further, WhoSent analyzes the reputation (FIG. 1, 112) of all of these data points (FIG. 2), explicit and inferred, correlated with situational data (FIG. 1, 111). If someone gives the WhoSent engine a message it will understand all of the available and implied data in that and related to that message. For example, email messages typically contain headers which are a transcript of that message's transit path:

Return-path: <bounces-user= example.com@ctrl.news.example.com>
Envelope-to: theuser@example.com
Delivery-date: Fri, 19 Jun 2009 05:49:46 −0400
Received: from localhost ([127.0.0.1] helo= server1.example.net]

by server1.example.net with esmtp (Exim 4.69)
(envelope-from
<bounces-theuser=example.com@ctrl.news.example.com>)
id 1MHajB-0007Sm-AL
for theuser@example.com; Fri, 19 Jun 2009 05:49:46 −0400

Received: from sat0-wow. news.example.com ([69.73.151.53]

helo=sat0-wow.internalsecuritysystems.com) with IPv4:25 by

server1.example.net;

19 Jun 2009 05:49:45 −0400

Received: from sat0-wow. news.example.com (wow.salaar.com
[127.0.0.1])

by sat0-wow. news.example.com (Postfix) with ESMTP id
126C51BC831
for <theuser@example.com>; Fri, 19 Jun 2009 10:49:44 +0100
(BST)

Date: Fri, 19 Jun 2009 09:49:44 −0000
Subject: The Vision is Spreading
From: “Security Solutions, Inc.” <e-mail@group.example.com>
To: <theuser@example.com>
reply-to: “ Security Solutions, Inc.” <e-mail@group.example.com>
MIME-Version: 1.0
Content-Type: multipart/alternative; boundary=“----=_NextPart_divider”
Message-Id: <20090619094944.126C51BC831@sat0-wow.
news.example.com>
X-Assp-Delay: theuser@example.com not delayed (spamlover);
19 Jun 2009

05:49:45 −0400

X-Assp-Whitelisted: Yes
X-Assp-Envelope-From:
bounces-theuser=example.com@ctrl.news.example.com
X-Assp-Intended-For: theuser@example.com

The Who Sent engine will look at each of these data points and use the historic data in combination with real-time analysis from the reputation database, external sources (FIG. 1, 117) and all data sources depicted in FIG. 1 to produce valid analysis of the authenticity of the actual sender.

### Detection of IP Device Compromise

Device fingerprinting will implant a unique identifier (FIG. 2) calculated from all the available data (FIG. 2, 202-208) in each device (FIG. 2), this identifier combined with other available attributes of FIG. 1 data sources including the reputation data (FIG. 1, 111) will be combined and hashed to produce a unique identifier. If someone gives the IP authentication engine a device it will understand all of the available and implied data (FIG. 2) in that and related to that device (FIG. 1). For example, network devices typically are identified by services provided, software running, and network address information. The IP authentication engine will look at each of these data points and use the historic data in combination with real-time analysis (FIG. 1, 111) to produce valid information.

We call this Contextual Meta-data. For example, this data includes characteristics of IP devices, networks connecting to other networks and routers and utilization of network based services, such as DNS, to enable them communicate. The context of each device (Contextual Meta-data) can be observed and memorialized over time.

The combination of device meta-data fingerprinting and Contextual Meta-data awareness exponentially increase the ability to identify and authenticate IP devices and can be used in spoofing and other intrusions.

### Detection of Reputation Compromise

The reputation database (FIG. 3) can passively obtain a visitor's DNS resolver settings instantly upon that user initiating a visit to any website. This is the map being used by a visitor to get to a website. And this map is one critical element to making a determination about the authenticity and vulnerability of customers logging into a site, and preventing financial loss for both the customer and the website.

For example:

One router “should” have a “natural” path to another router. If this is not the case now or has not been over time, the analysis engine (FIG. 1, 111) with the data (FIG. 1, 112) and other sources is able to understand why. The analytical engine (FIG. 1, 111) through observation and correlation of the data stored in databases (FIG. 3) and the Contextual Meta-data and can therefore subjectively assess a directional change in reputation.

It should be noted that taken alone the data may not be compelling . . . taken in context the data and the information from all sources in FIG. 1 is compelling.

### Global Situational Awareness and Correlation

One embodiment of the present invention allows real-time alerts to be issued based on the present and historical situational DNS data (FIGS. 1, 2 and 3), and especially the real-time and historical meta-data and Contextual Meta-data. In one embodiment of the present invention, the events will be correlated (FIG. 1, 111), both present and historical, across multiple locations, and activates and via the alert engine (FIG. 1, 113) one or more actions in response to the correlation exceeding a particular threshold. As previously described, the correlation process may evaluate various rules, such as “issue an alert to a given destination when data differs over a given period of time.” Analytic accesses is used to extract relevant events from the situational DNS data and all data depicted in FIG. 1, and are input into the correlation process (FIG. 1, 111). Input may also come from other systems (e.g. FIG. 1, 117) and other networked based sensors and/or logs. Various actions may be taken under certain conditions, and may be activated by the alert/action engine when a certain set of conditions are met.

In addition to alerting on the occurrence of primitive or compound events, the present invention may also alert based on an accumulated value of multiple events across space and time. Equations 1 to 3 show possible rules that may be evaluated by the correlation process. For example, as shown in Eq. 1, action component a, will be activated if the expression on the left-hand side is greater than a predetermined threshold, T₁. In Eqs. 1-3, “a” stands for an action, “w” stands for attribute weights, “x” stands for non-DNS events, and “d” stands for DNS events. Eqs. 1-3 could represent a hierarchy of actions that would be activated for different threshold scenarios. Eqs. 1-3 are illustrative of only one embodiment of the present invention, and the present invention may be implemented using other equations, other expressions.

$$\begin{matrix}{a}_{1} : {\sum }_{i = 1}^{i = N} {w}_{i} + {x}_{i} + {\sum }_{i = 1}^{m} {w}_{i} + {d}_{i} \geq {τ}_{1} & ( 1 ) \\ {a}_{2} : {\sum }_{i = 1}^{i = N} {w}_{i} + {x}_{i} + {\sum }_{i = 1}^{m} {w}_{i} + {d}_{i} \geq {τ}_{2} \\ … & ( 2 ) \\ {a}_{n} : {\sum }_{i = 1}^{i = N} {w}_{i} + {x}_{i} + {\sum }_{i = 1}^{m} {w}_{i} + {d}_{i} \geq {τ}_{n} & ( 3 )\end{matrix}$$

Equation 4 shows an example of a calculation for determining weights. The weights “wᵢ” may be a weighted average of attribute data (aᵢ), including resolution of the situational DNS data (R, “Src_AW_Quality”), age of the data used to capture the situational DNS data (A, “Src_AW_Age”), time since last instance of the situational DNS data (TM, “Src_AW_Currency”), and reliability of the source of the situational DNS data (RS, “Src_AW_Reliability”). Note that a similar expression can be used to calculate the importance (Y) of data by the IP authentication module when determining when to validate a device. Other weighting factors may also be used, and the weighing factors described here are illustrative only and are not intended to limit the scope of the invention.

$${w}_{i} = {\sum }_{k = 0}^{N} {ω}_{k} {a}_{k} \qquad ( 4 )$$

In equation 4, ωₖ are relative weights of the attributes (aₖ), which are themselves weights associated with the data sources. The preceding equations are illustrative of but one manner in which the present invention may be implemented and are not intended to limit the scope to only these expression(s).

Reputation data may be cascaded down the decision tree based on its importance (Y). The data may also be cascaded upward to “reset”. The importance (Y) may be calculated as a weighted average of the attributes of the reputation data (including attributes of the device used to capture the reputation data). Examples of attributes of the reputation data include, but are not limited to, the following:

The data depicted in FIG. 3.

IP

Entities

Devices

Networks

Entity Detail

DNS

Path History

Device History

Intrusion

Black Lists

Performance

As well as data from all sources in FIG. 1

Importance of the reputation data (Y) is used to cascade the reputation data, and may be calculated as a weighted average, as shown in Equation A.

$$Y = {\sum }_{i = 1}^{i = N} {w}_{i} \cdot {a}_{i} \qquad ( A )$$

where Y=importance of the data, aᵢ=attributes of the data (Σ aᵢ=1), wᵢ=relative weights of the attributes (Σ wᵢ=1), and N=total number of attributes.

If t₀≦Y≦1 then data is stored in highest (first) hierarchy.

If t₁≦Y≦t₀ to then data is stored in second hierarchy.

If t₂≦Y≦t₁ then data is stored in third hierarchy.

. . .

If 0≦Y≦tₙ, then data is stored in lowest (last) hierarchy, where 1>t₀>t₁>t₂> . . . >tₙ>0

For example, in a case of six attributes each weighted equally, the importance Y may be calculated as shown in Equation B:

Y=(L+R+A+RS+TM+TS)/6 (B)

### Forensic Analysis

Forensic analysis and event correlation across both space and time may be performed using the database schemas described here according to the principles of the present invention. The events, both primitive and compound, that are recorded in the Entities (FIG. 3, 304) and Entity Detail (FIG. 3, 303) database tables may be used as indices into the meta-data. After the data and meta-data have been stored in these tables, this data may be used to significantly enhance search and retrieval of the data. That is, in order to perform a search of the data, the tables may be searched first, and the data may be an index of itself.

For example, suppose an event was recorded in the Entities and EntityDetail tables during detection of a change in a particular device. If at a later time it were desired to locate all places in the data where a that change was detected, a database query would be performed on these tables to retrieve all events where device changes were noted. The pointers to the data and the indices into the data would provide a mechanism by which to retrieve the data that corresponds to those occurrences of changes.

FIG. 17 shows a possible set-theoretic explanation of the operation of the above historical analysis. Consider the sets of data D₁, D₂, . . . , Dᵢ shown as elements 17a, 17n, and 17o in FIG. 17 respectively. Sets D₁ (element 17a) and D₂ (element 17n) represent data from device 1 and device 2, respectively, and so on. Each set of data Dᵢ has subsets of data, for example, subsets for a particular date range, for a particular time range, for a particular event, etc. For example, set 17a has subsets of data identified as elements 17d, 17e, 17f and 17g in FIG. 17.

Each set of data Dᵢ has a corresponding set of meta-data Mᵢ associated with it. Each element in the set of meta-data Mᵢ has an index, or a pointer, to a corresponding portion of the data Dᵢ. For example, meta-data set M₁, shown as element 17b in FIG. 17, has corresponding subsets of meta-data, shown as elements 17h, 17i, 17j and 17k. Each subset of meta-data is indexed, or points to, a corresponding subset of data. For example, subset 17k of meta-data M₁ is indexed, or points to, subset 17e of data D₁ from device 1 (not shown). Note that a one-to-one relationship between data and meta-data is illustrated in FIG. 17 for clarity. The relationship between data and meta-data is not restricted to being one-to-one. The relationship may be one-to-many, many-to-one, as well as many-to-many.

In addition, sets Wᵢ of attribute weight data are weight vectors associated with each set of meta-data Mᵢ for device i (not shown). The sets Wᵢ of attribute weight data are sets of vectors W_{i,j} which represent weights associated with subsets of the meta-data Wᵢ. For example, weight vector W_{i,j} represented as element 17m, represents the weights associated with meta-data subset 17j. The weight vectors W_{i,j} may be n-dimensional vectors representing the weights in one of a number of dimensions, each dimension representing a weight in a particular attribute of the data. For example, a 2-dimensional weight [w₁₁, w₁₂] vector may represent the attribute weights associated with the reliability of a particular device for both reliability as well as change detection reliability. One device may have reliability and low change detection reliability, while another device may have high change detection reliability and low reliability. In principle, the attribute weight vectors wᵢⱼ may be arbitrarily fine-grained with respect to subsets of the meta-data and subsets of the data. In practice, attribute weight vectors wᵢⱼ are constant over large subsets of the meta-data and the data, and may have large discontinuities between subsets. For example, change detection may have a very low reliability weight, and very high change detection reliability, and vice versa for typical devices.

The set-theoretic described has been shown and described here for ease of understanding and explanation of the present invention. The meta-data and data may or may not be stored as sets; the data may be stored in matrices, tables, relational databases, etc. The set description is shown for clarity only. The present invention is not limited to this particular mathematical representation, and one of ordinary skill will recognize numerous alternative and equivalent mathematical representations of the present invention.

A possible query to retrieve those events in which a person was detected would be:

SELECT*FROM EVENTS WHERE MDParameterID=10 (1)

Query (1) would retrieve all events where a device was detected. In the set-theoretic notation described above, the query (1) would correspond to:

∀xⱼ∈Vᵢ|M_{i,j}(MDParameterID=10) (2)

In order to view the data corresponding to a particular event, a possible follow-on query would be:

VIEW EVENT 1 (3)

Similar queries could be used to retrieve other events. For example, in order to retrieve all reliability events, a possible query would be:

SELECT*FORM EVENTS WHERE MDParameterID=12 (4)

Query (4) would be represented in set-theoretic notation as:

∀xⱼ∈Vᵢ|M_{i,j}(MDParameterID=12) (5)

To view the first 3 events where reliability change was detected, a possible query would be:

VIEW EVENT1,2,3 (6)

Another possible query, to search for all data where a device change was detected, a possible query would be:

SELECT*FROM EVENTS WHERE MDParameterID=11 (7)

Query (7) would be represented in set-theoretic notation as:

∀xⱼ∈Vᵢ|M_{i,j}(MDParameterID=11) (8)

Similarly, in order to view the data corresponding to the first two events where a device change was detected, a possible query would be:

VIEW EVENT1,2 (9)

Event searches may be restricted by particular locations or date-ranges. For example, an analyst may only wish to search a particular device, or location, where change was detected, for example:

SELECT*FROM EVENTS WHERE MDParameterID=6 AND SrcID=1 (10)

Query (10) would be represented in set-theoretic notation by restricting the search to Dᵢ (data from device 1) as follows:

∀xⱼ∈Vᵢ|M_{i,j}(MDParameterID=6) (11)

The security analyst may also restrict searches by date and/or time. For example, the security analyst may only wish to search a particular date range where motion was detected, for example:

SELECT*FROM EVENTS WHERE MDParameterID=6 AND MD_Event-DateTime>=09/26/2007 (12)

Query (12) may be represented in set-theoretic notation as:

∀xⱼ∈Vᵢ|{M_{i,j}(MDParameterID=6) ∩ M_{i,j}(MD_Event_DateTime≧(09-26-2007)) (13)

Multiple events may also be searched. For example, an analyst may want to search historical data for all occurrences where a certain network event was detected. A possible query to accomplish this would be:

SELECT*FROM EVENTS WHERE MDParameterID=10 OR MDParameterID=16 (14)

Query (14) may be represented in set theoretic notation as:

∀xⱼ∈Dᵢ|{M_{i,i}(MDParameterID=10)∩ M_{i,i}(MDParameterID=16) (15)

Any number of combinations and sub-combinations of events may be searched using the query language, including unions and intersections (conjunctions and disjunctions) of events using AND/OR operators, as well as other logical operators.

Events may also be correlated and analyzed across multiple devices, or multiple locations. For example, a analyst may want to see all events where change was detected in a particular network, or a data stream was detected in at a certain device. To perform such a search, the security analyst could search by:

SELECT*FROM EVENTS WHERE (MDParameterID=6 AND SrcID=1) OR (MDParameterID=15 AND SrcID=2) (16)

Query (16) may be interpreted in set-theoretic notation as:

∀xⱼD₁ ∩ D₃|{M_{i,j}(MDParameterID=6) ∩ M_{2,j}(MDParameterID=15) (17)

The analyst is not required to use a query language. A query language may be used for sophisticated searches. For more basic searches, a user interface is provided for the analyst, which allows the analyst to select the meta-data criteria by which to search by using a visual tool. The user interface automatically generates the query language and queries the database for retrieval.

A possible structured query language was shown here. However, the present invention is not limited to the query language shown or described here. Any number of query languages are within the scope of the present invention, including SQL, IBM BS 12, HQL, EJB-QL, Datalog, etc. The query languages described here is not meant to be an exhaustive list, and are listed here for illustrative purposes only.

When performing queries on meta-data, such as unions and intersections, attribute weights may be recalculated. For example, to recalculate the attribute weights for an intersection of two subsets of meta-data, the attribute weights would be multiplied together, as shown:

W(M₁ ∩ M₂)=W(M₁)·W(M₂) (18)

For example, to calculate the weight associated with two events occurring substantially simultaneously, where the first event has a reliability of 90% (0.90), and the second event has a probability of 50% (0.50), the weight associated with both motion events substantially simultaneously is 45% (0.45).

To recalculate the attribute weights for a union of two subsets of meta-data, the law of addition of probabilities would be applied, as shown:

W(M₁ ∩ M₂)=W(Mᵢ)+W(M₂)−W(M₁)·W(M₂) (19)

For example, to calculate the weight associated with either one of two events occurring substantially simultaneously, where the first event has a reliability of 90% (0.90), and the second event has a probability of 50% (0.50), the weight associated with either one of the events occurring substantially simultaneously is 95% (0.95).

### Reputation Database Correlation and Alerting

One embodiment of the present invention allows real-time alerts to be issued based on the present and historical data, and especially the present and historical vulnerability events. In one embodiment of the present invention, the correlation process correlates vulnerability events, both present and historical, across multiple IP devices and multiple locations, and activates via the alert/action engine one or more actions in response to the correlation exceeding a particular threshold. As previously described, the correlation process may evaluate various rules, such as “issue an alert to a given destination when a given vulnerability/situation is detected in a given device class/scenario during a designated time.” Security vulnerability detectors are used to detect vulnerability events in the IP devices, which are then input into the correlation process. Input may also come from other systems, such as logs, real-time path analysis, round-trip-time, time to live, accessibility, FBI files, police records, blacklists. Various actions may be taken under certain conditions, and may be activated by the alert/action engine when a certain set of conditions are met.

In addition to alerting on the occurrence of primitive or compound events, the present invention may also alert based on an accumulated value of multiple events across space and time. Equations 1 to 3 show possible rules that may be evaluated by the correlation engine. For example, as shown in Eq. 1, action component a₁ will be activated if the expression on the left-hand side is greater than a predetermined threshold, T₁. In Eqs. 1-3, “a” stands for an action, “w” stands for attribute weights, “x” stands for one class of vulnerability events, and “v” stands for another class of vulnerability events. Eqs. 1-3 could represent a hierarchy of actions that would be activated for different threshold scenarios. Eqs. 1-3 are illustrative of only one embodiment of the present invention, and the present invention may be implemented using other equations and other expressions.

### Implementation

FIG. 16 depicts a three-tier Architecture. This architecture separates the presentation from the logic and logic from the data. This allows for much greater scalability and allows for changes to be made in one tier without affecting the other tier. The tiers are as follows: one (16a) the presentation tier; which consists of the methods and context for presentation of data to humans. Typically the presentation tier can be characterized by the graphical user interface as demonstrated on a handheld device such as an Apple iPhone, other Personal Digital Assistants (PDA's) and/or web browser based interfaces. Additionally an important attribute of the presentation tier is the attention paid to the target audience. For example, a Chief Financial Officer may need different data presented in a different format as compared to a law enforcement officer. Two (16b), the logic tier allows the data (16c) to be contextualized (correlated) and for analysis to occur. The logic tier may also be used to exercise forensic analysis on the data store in the date tier. Three (16c), the data tier is responsible for the storage and accessibility of all data. The data tier may also be responsible for some data reduction depending on the specific goals of the system. In this specific data tier we will see data as follows: DNS, reputation, e-mail histories, routing information, latency information, path analysis and many others. This architecture will be used in the hardware or software implementation of: Who Sent engine, reputation database, analytical engine, alert engine, escalation engine, reporting engine and the IP authentication engine.

### Real World Scenarios

See examples in BACKGROUND OF INVENTION. Each one of these intrusions can be mitigated with the inventions presented here.

### Alternative Embodiments

FIG. 16 can also be implemented as a hardware embodiment.

What is claimed is:

1. A situational awareness detection and alerting system comprising:
One or more IP Devices
One or more IP Networks
One or more DNS servers
One or more routers
One or more firewalls
One or more switches
One or more reputational databases
One or more border gateway protocol devices
One or more network access providers
One or more applications
One or more storage devices
One or more log files
One or more pathway files
A reputation engine—A method of hashing unique identification of IP devices
A historical database of previous situations and vulnerabilities in the internet portion of the cloud and how.
An alert engine
An escalation engine
A Who Sent engine
Which will allow one or more actions based on the analysis and decision capabilities of all of the above to put a weighting on the authenticity of who is accessing the cloud and internet.
one or more IP devices comprising an IP network;
one or more processors, operatively coupled to the one or more sensors; and
one or more memories, operatively coupled to the one or more processors, the one
or more memories comprising program code which when executed causes the one or more processors to:
a. monitor the one or more IP devices on the IP network;
b. detect one or more primitive vulnerability events in the IP devices;
c. generate attribute data representing information about the importance of the IP devices;
d. correlate two or more primitive vulnerability events, the primitive vulnerability events weighted by the attribute data of the IP devices; and
e. perform one or more actions based on the correlation performed in the correlating step.

2. The system of claim number one further comprising program code to:
Determining the veracity of an IP device using historical path access analysis, unique IP identifiers, reputation data and outside data.

3. The system of claim number one further comprising program code to:
Alert on probable violations and compromises and anomalies in any part of the internet portion of the cloud based on an accumulated reputational database.

4. The system of claim number one further comprising program code to:
With the addition of conventional network monitoring programs, provide an alerting and global awareness dashboard for the entire cloud.

5. The system of claim number one further comprising program code to:
Mature previously determined reputational flaws based on present real-time and historical baseline data.

6. The system of claim 1, further comprising program code to normalize the primitive vulnerability events.

7. The system of claim 1, further comprising program code to filter out primitive events based on a set of rules.

8. The system of claim 1, further comprising program code to detect compound events composed of two or more primitive vulnerability events.

9. The system of claim 4, further comprising program code to:
time correlate the primitive vulnerability events and the compound events across time;
space correlate the primitive vulnerability events and the compound events across space; and
evaluate one or more rules based on the correlation performed in the time correlating step and the space correlating step.

10. The system of claim 5, further comprising program code to:
generate one or more new rules based on the primitive events correlated in the correlating step and the actions performed in the action step.

11. The system of claim 1, further comprising program code to:
receive tip data from one or more external sources;
determine attribute data for the tip data, the attribute data representing the reliability of a source of the tip data; and
generate tip events based on the tip data and the attribute data.

12. The system of claim 1, wherein the one or more IP devices are IP surveillance cameras.

13. The system of claim 1, further comprising program code to:
monitor network status of the IP devices; and
generate network events reflective of the network status of the IP devices.

14. The system of claim 1, wherein the program code to generate attribute data representing information about the importance of the IP devices further comprises program code to:
determine one or more weights for the primitive vulnerability events based at least on the reliability of the IP devices.

15. The system of claim 14, further comprising program code to:
determine one or more weights using a weight corresponding to a time the primitive vulnerability event was received and a weight corresponding to a frequency that the primitive vulnerability event was received.

16. The system of claim 14, further comprising program code to:
determine one or more weights by using a weight based on events external to the IP devices.

17. A vulnerability detection and alerting system for detecting compromise of one or more IP devices on an IP network, the system comprising:
a detector adapted to detect one or more primitive vulnerability events in the IP devices;
an attribute engine adapted to generate attribute data representing information about the importance of the IP devices;
a correlation engine adapted to correlate two or more primitive vulnerability events weighted by the attribute data of the IP devices; and an action engine adapted to perform one or more actions based on the correlation performed by the correlation engine.

18. The system of claim 17, further comprising a normalization engine adapted to normalize the primitive vulnerability events.

19. The system of claim 17, further comprising a filter adapted to filter out primitive vulnerability events based on a set of rules.

20. The system of claim 17, further comprising a compound event detector adapted to detect compound events composed of two or more primitive vulnerability events.

21. The system of claim 20, further comprising:
a time correlator adapted to correlate the primitive vulnerability events and the compound events across time;
a space correlator adapted to correlate the primitive vulnerability events and the compound events across space; and
a rules engine adapted to evaluate one or more rules based on the correlation performed by the time correlator and the space correlator.

22. The system of claim 21, further comprising a learning engine adapted to generate one or more new rules based on the primitive vulnerability events correlated by the correlating process and the actions performed by the action engine.

23. The system of claim 17, wherein the one or more IP devices are IP surveillance cameras.

24. The system of claim 17, wherein the attribute data representing information about the importance of the IP devices is determined based at least on the reliability of the IP devices.

25. The system of claim 24, wherein the attribute data representing information about the importance of the IP devices is determined by using a weight corresponding to a time the primitive vulnerability event was received and a weight corresponding to a frequency that the primitive vulnerability event was received.

26. The system of claim 24, wherein the attribute data representing information about the importance of the IP devices is determined by using a weight based on events external to the IP devices.

27. A method for detecting vulnerabilities in IP networks having one or more IP devices, the method comprising the steps of:
monitoring the one or more IP devices on the IP network;
detecting one or more primitive vulnerability events in the IP devices;
generating attribute data representing information about the importance of the IP devices;
correlating two or more primitive vulnerability events, the primitive vulnerability events weighted by the attribute data of the IP devices; and
performing one or more actions based on the correlation performed in the
correlating step.

28. The method of claim 27, further comprising normalizing the primitive vulnerability events.

29. The method of claim 27, further comprising:
filtering out primitive vulnerability events based on a set of rules.

30. The method of claim 27, further comprising:
detecting compound events composed of two or more primitive vulnerability events.

31. The method of claim 30, further comprising:
time correlating the primitive vulnerability events and the compound events
across time;
space correlating the primitive vulnerability events and the compound events
across space; and
evaluating one or more rules based on the correlation performed in the time
correlating step and the space correlating step.

32. The method of claim 31, further comprising:
generating one or more new rules based on the primitive vulnerability events correlated in the correlating step and the actions performed in the action step.
monitoring the one or more IP devices on the IP network;
detecting one or more primitive vulnerability events in the IP devices;
generating attribute data representing information about the importance of the IP
devices;
correlating two or more primitive vulnerability events, the primitive vulnerability
events weighted by the attribute data of the IP devices; and
performing one or more actions based on the correlation performed in the
correlating step.

33. The method of claim 27, further comprising:
normalizing the primitive vulnerability events.

34. The method of claim 27, further comprising:
filtering out primitive vulnerability events based on a set of rules.

35. The method of claim 27, further comprising:
detecting compound events composed of two or more primitive vulnerability events.

36. The method of claim 30, further comprising:
time correlating the primitive vulnerability events and the compound events
across time;
space correlating the primitive vulnerability events and the compound events
across space; and
evaluating one or more rules based on the correlation performed in the time
correlating step and the space correlating step.

37. The method of claim 31, further comprising:
generating one or more new rules based on the primitive vulnerability events
correlated in the correlating step and the actions performed in the action step.

38. The method of claim 27, further comprising:
receiving tip data from one or more external sources;
determining attribute data for the tip data, the attribute data representing the
reliability of a source of the tip data; and
generating tip events based on the tip data and the attribute data.

39. The method of claim 27, wherein the one or more IP devices are IP surveillance cameras.

40. The method of claim 27, further comprising:
monitoring DNS status of the IP devices; and
generating network events reflective of the network status of the IP devices.

41. The method of claim 27, wherein the step of generating attribute data representing information about the importance of the all devices on the internet further comprises the step of:
determining one or more weights for the primitive vulnerability events based at least on the reliability of the all devices.

42. The method of claim 36, further comprising:
determining attribute data by using a weight corresponding to a time the primitive vulnerability event was received and a weight corresponding to a frequency that the primitive vulnerability event was received.

43. The method of claim 36, further comprising:
determining attribute data by using a weight based on events external to the IP devices, data, paths.

44. A method of detecting and alerting on possible IP network compromise, comprising the steps of: 33. The method of claim 27, further comprising:
receiving tip data from one or more external sources;
determining attribute data for the tip data, the attribute data representing the reliability of a source of the tip data; and
generating tip events based on the tip data and the attribute data.
detecting at least one potential denial of service attack as a first set of vulnerability events;
detecting at least one potential unauthorized usage attempt as a second set of vulnerability events;
detecting at least one potential spoofing attack as a third set of vulnerability events;
detecting at least one compromise of a DNS server;
detecting at least one blacklist listing;
detecting at least one user that authorities identified;
detecting at least one improper time interval for DNS records;
detecting at least one non-matching mail server;
detecting at least one unreachable internet device based on DNS advertising;
correlating the first set of vulnerability event, the second set of vulnerability event, and the third set of vulnerability events; and
sending one or more alerts based on the correlation performed in the correlating step.

45. The method of claim 39, wherein the denial of service attack is detected by a service survey.

46. The method of claim 39, wherein the denial of service attack is detected by a historical benchmark analysis.

47. The method of claim 39, wherein the denial of service attack is detected by a traceroute.

48. The method of claim 39, wherein the unauthorized usage is detected by a passive DNS query.

49. The method of claim 39, wherein the unauthorized usage is detected by log analysis.

50. The method of claim 39, wherein the unauthorized usage is detected by correlations of unusual behavior.

51. The method of claim 39, wherein the spoofing attack is detected by a fingerprint of the IP device's HTTP server.

52. The method of claim 39, wherein the spoofing attack is detected by a fingerprint of the IP device's TCP/IP stack.

53. The method of claim 39, wherein the spoofing attack is detected by a fingerprint of the IP device's configuration settings.

54. The method of claim 39, wherein the spoofing attack is detected by a watermark in a data stream of the IP device.

55. The method of claim 39, wherein the spoofing attack is detected by burning a unique private key in the IP device's physical memory.

56. A system for detecting and alerting on possible compromise of an IP network having one or more IP devices, the system comprising:
a vulnerability detection engine for detecting one or more vulnerabilities in the IP network;
a correlation and analysis process adapted to correlate two or more vulnerabilities weighted by
an importance of the IP device; and
an action engine adapted to perform one or more actions based on the correlation
performed by the correlation and analysis process.

57. The system of claim 51, wherein the vulnerability detection engine comprises:
means for detecting at least one potential denial of service attack.

58. The system of claim 52, wherein the denial of service attack is detected by a service survey.

59. The system of claim 52, wherein the vulnerability is detected by a historical benchmark analysis.

60. The system of claim 52, wherein the vulnerability is detected by a traceroute.

61. The system of claim 51, wherein the vulnerability detection engine comprises:
means for detecting at least one potential unauthorized usage attempt.

62. The system of claim 56, wherein the unauthorized usage is detected by a passive DNS query.

63. The system of claim 56, wherein the unauthorized usage is detected by log analysis.

64. The system of claim 56, wherein the unauthorized usage is detected by correlations of unusual behavior.

65. The system of claim 51, wherein the vulnerability detection engine comprises:
means for detecting at least one potential spoofing attack.

66. The system of claim 60, wherein the spoofing attack is detected by a fingerprint of the IP device's HTTP server.

67. The system of claim 60, wherein the spoofing attack is detected by a fingerprint of the IP device's TCP/IP stack.

68. The system of claim 60, wherein the spoofing attack is detected by a fingerprint of the IP device's configuration settings.

69. The method of claim 60, wherein the spoofing attack is detected by a watermark in a data stream of the IP device.

70. The method of claim 60, wherein the spoofing attack is detected by burning a unique private key in the IP device's physical memory.

71. The system of claim 51, wherein the correlation analysis process comprises:
a normalization engine adapted to normalize the primitive vulnerability events;
a filter adapted to filter out primitive events based on a set of rules;
a compound event detector adapted to detect compound events composed of two
or more primitive vulnerability events;
a time correlator adapted to correlate the primitive vulnerability events and the
compound events across time;
a space correlator adapted to correlate the primitive vulnerability events and the
compound events across space; and
a rules engine adapted to evaluate one or more rules based on the correlation
performed by the time correlator and the space correlator.

72. The system of claim 51, further comprising a network management module, wherein the network management module further comprises:
means for monitoring network status of the IP devices; and
means for generating network events reflective of the network status of the IP devices.

73. The system of claim 1 thru 73, for reporting the results in written form.

74. The system of claim 1 thru 74, for reporting the results in a dashboard.

75. The system of claim 1 thru 74 further comprising of program code for implementation in a three-tier architecture: presentation, analytics and data.

76. The system of claim 1 thru 74 further comprising user interface dashboards with the look and feel of matrices that intersecting points that indicate the relative size of the risks of vulnerabilities.

77. The system of claim 1 thru 74 further comprising contextual memorializing of network access points, network paths, connected devices, gateways, DNS data, log files, load analysis and the data that traverses such devices and as such produces a natural, discernible, mathematical model of such flows. This model of events and contexts may be predictable as aberrations occur making these aberrations and their effects transparent.

78. The system of claim 77 further comprising of a dynamic/real-time data model for the contextual information observed as part of the continuous action of these systems memorialized over time.

79. The system of claim 77 further comprising the assertion that routes should not be random and should have some natural order to them based on the underlying principles of network routing, memorializing these routes over time and observing flows which occur outside of the norm. Such observations can be subjectively assessed as directional change in reputation.

80. A system of claim number one further comprising program code to:
With the addition of analytical engine, reputational database, the ip authentication engine, and path analysis, provide an identification of who sent the message.
